(19) United States
(12) Patent Application Publication
(10) Pub. No.: US 2012/0051662 A1
(43) Pub. Date: Mar. 1, 2012

(54) IMAGE PROCESSING APPARATUS AND STORAGE MEDIUM

(75) Inventor: Yukihiro NAITO, Tokyo (JP)

(73) Assignee: OLYMPUS CORPORATION, Tokyo (JP)

(21) Appl. No.: 13/212,487

(22) Filed: Aug. 18, 2011

(30) Foreign Application Priority Data
Aug. 24, 2010 (JP) 2010-186950

(51) Int. Cl. G06K 9/40

(52) U.S. Cl. 382/275

(57) ABSTRACT

Motion vectors between images are acquired from a plurality of images acquired by an image pickup device. A first motion vector candidate corresponding to a local area near a processing target pixel is calculated by a first motion vector candidate calculating unit. A second motion vector candidate corresponding to a global area larger than the local area is calculated by a second motion vector candidate calculating unit. Image synthesis is performed using an image corrected based on the first or second motion vector candidates.

### FIELD OF THE INVENTION

The present invention relates to an image processing apparatus and a storage medium.

### BACKGROUND OF THE INVENTION

To obtain an image with less noise upon picking up a still image in an image pickup apparatus such as a digital camera, it is effective to ensure a sufficient exposure time. However, if the exposure time is extended, there is a problem of blurring an image and making the image unclear due to a movement of a camera due to a camera shake and a movement of an object. An electronic blur correction method has been proposed as a method for dealing with such a blur.

For example, JP4178481B discloses a method for obtaining a good blur-free image by synthesizing a plurality of images after successively performing an image pickup operation in a short exposure time to cause a little blur a plurality of times and performing a position adjustment process by global motion vectors (motion vectors representing moved amounts of the entire images) so that motions between the obtained plurality of images are canceled.

There is also a method for performing a position adjustment process and a synthesis process not by calculating one global motion vector for an image, but by utilizing local motion vectors which differ depending on positions in an image.

For example, JP2007-36741A discloses a method capable of dealing with even cases where objects moving in a plurality of directions is present in an image by increasing the number of target blocks for which motion vectors are calculated. JP2007-36741A also discloses a method for detecting a moving object, detecting motion vectors in an area including the detected moving object and selecting the motion vector suitable at each position of an image from these pluralities of motion vectors.

### SUMMARY OF THE INVENTION

One aspect of the present invention is directed to an image processing apparatus, including an image acquiring unit that acquires a plurality of images, a motion information acquiring unit that acquires motion information between the plurality of images, and a synthesizing unit that corrects at least one image out of the plurality of images based on the motion information and synthesizes the corrected image and at least one other image acquired by the image acquiring unit. The synthesizing unit includes a first motion vector candidate calculating unit that calculates a first motion vector candidate corresponding to a local area near a unit area for each unit area composed of a single pixel or a plurality of pixels, and a second motion vector candidate calculating unit that calculates a second motion vector candidate corresponding to a global area near the unit area and larger than the local area for each unit area, and corrects at least one image out of the plurality of images based on at least either the first motion vector candidates or the second motion vector candidates and synthesizes the corrected image and the at least one other image acquired by the image acquiring unit.

Another aspect of the present invention is directed to a non-temporary computer-readable storage medium storing an image processing program for processing a picked-up image by a computer, the image processing program causing the computer to perform an image acquiring procedure for acquiring a plurality of images, a motion information acquiring procedure for acquiring motion information between the plurality of images, and a synthesizing procedure for correcting at least one image out of the plurality of images based on the motion information and synthesizing the corrected image and at least one other image acquired by the image acquiring procedure. In the synthesizing procedure, a first motion vector candidate calculating procedure for calculating a first motion vector candidate corresponding to a local area near a unit area for each unit area composed of a single pixel or a plurality of pixels, and a second motion vector candidate calculating procedure for calculating a second motion vector candidate corresponding to a global area near the unit area and larger than the local area for each unit area are further performed, and at least one image out of the plurality of images is corrected based on at least either the first motion vector candidates or the second motion vector candidates and the corrected image and the at least one other image acquired by the image acquiring procedure are synthesized.

### BRIEF DESCRIPTION OF THE DRAWINGS

FIG. 1 is a schematic construction diagram showing an image processing apparatus in a first embodiment of the present invention.

FIG. 2 is a diagram showing a procedure of synthesizing images in the first embodiment.

FIG. 3 is a diagram showing a block matching method.

FIG. 4 is a schematic construction diagram showing a synthesis processing unit in the first embodiment.

FIG. 5 is a diagram showing a method for calculating a motion vector candidate.

FIG. 6A is a graph showing a method for determining a first synthesis ratio in the first embodiment.

FIG. 6B is a graph showing a method for determining a second synthesis ratio in the first embodiment.

FIG. 7A is a graph showing another method for determining the first synthesis ratio in the first embodiment.

FIG. 7B is a graph showing another method for determining the second synthesis ratio in the first embodiment.

FIG. 8 is a schematic construction diagram showing a synthesis processing unit in a second embodiment of the present invention.

FIG. 9A is a graph showing a method for determining a first synthesis ratio in the second embodiment.

FIG. 9B is a graph showing a method for determining a second synthesis ratio in the second embodiment.

FIG. 10 is a schematic construction diagram showing a synthesis processing unit in a third embodiment of the present invention.

FIG. 11A is a graph showing a method for determining a first synthesis ratio in the third embodiment.

FIG. 11B is a graph showing a method for determining a second synthesis ratio in the third embodiment.

### DESCRIPTION OF PREFERRED EMBODIMENTS

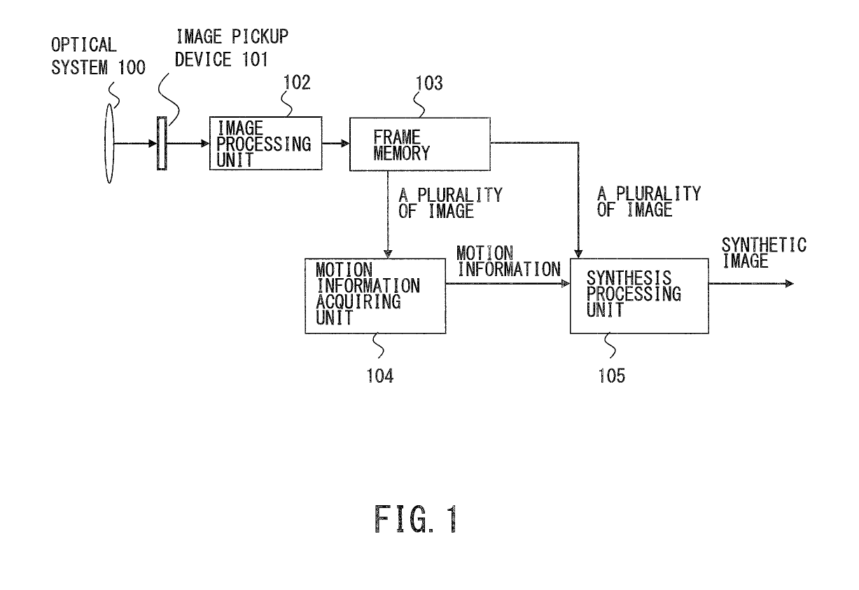

An image processing apparatus in a first embodiment of the present invention is described with reference to FIG. 1. FIG. 1 is a schematic construction diagram showing the image processing apparatus of the first embodiment.

The image processing apparatus in this embodiment includes an optical system 100, an image pickup device 101, an image processing unit 102, a frame memory 103, a motion information acquiring unit 104 and a synthesis processing unit 105.

The image pickup device 101 outputs an electrical signal corresponding to light incident on a light receiving surface via the optical system 100 constructed by a lens or the like at a predetermined timing. The image processing unit 102 outputs an image signal, which is obtained by performing image processings such as a color processing and a gradation conversion processing to the output electrical signal, to the frame memory 103. The image signal is stored as image data in the frame memory 103.

A plurality of image data having the image processings performed thereon are stored in the frame memory 103 by repeating the above image pickup process a specified number of times. In this embodiment, it is assumed that image data corresponding to a maximum of four images are to be synthesized and image data obtained by four image pickup operations are stored in the frame memory 103. Image data corresponding to one image is treated merely as an image below.

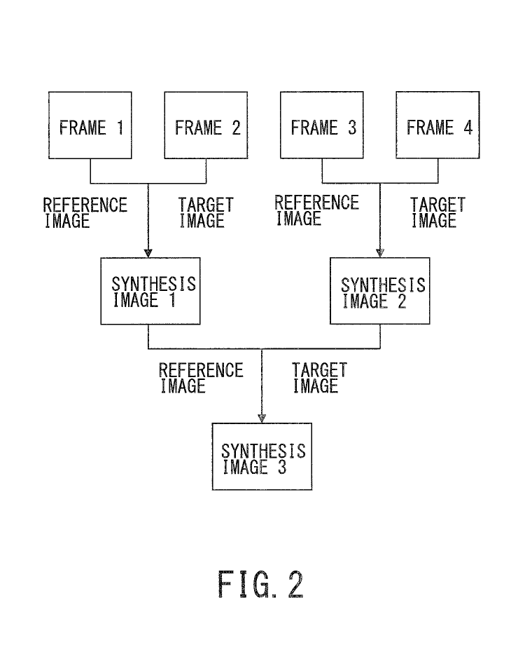

FIG. 2 shows an example of synthesizing one image from four images. In FIG. 2, the four images are frames 1 to 4, a basic process of synthesizing one image from two images is performed three times and, finally, one synthetic image is obtained from the four images.

First, a synthetic image 1 is generated by synthesizing the frames 1 and 2. At the time of synthesis, it is defined that one image is a reference image and the other is a target image. Here, the frame 1 is a reference image and the frame 2 is a target image. Subsequently, a synthetic image 2 is generated by synthesizing the frame 3 as a reference image and the frame 4 as a target image. Finally, a synthetic image 3 as a final result is generated by synthesizing the synthetic image 1 as a reference image and the synthetic image 2 as a target image.

Note that the method for synthesizing a plurality of images is not limited to this. For example, the synthetic image 1 and the frame 3 in FIG. 2 may be synthesized and a synthetic image obtained by the synthesis and the frame 4 may be synthesized. Further, it is also easily possible to synthesize a total of four images, i.e. one reference image and three target images instead of a total of two images, i.e. one reference image and one target image in the basic process of synthesis by extending the motion information acquiring unit 104 and the synthesis processing unit 105. In addition to determining an image picked up earlier as a reference image, an image picked up later may be determined as a reference image. It is also possible to use an image picked up at an intermediate timing as a reference by changing which of images picked up earlier and later should be used as a reference image every time the basic process is performed.

Operations of the motion information acquiring unit 104 and the synthesis processing unit 105 are described, assuming that two images, i.e. a reference image and a target image are to be processed.

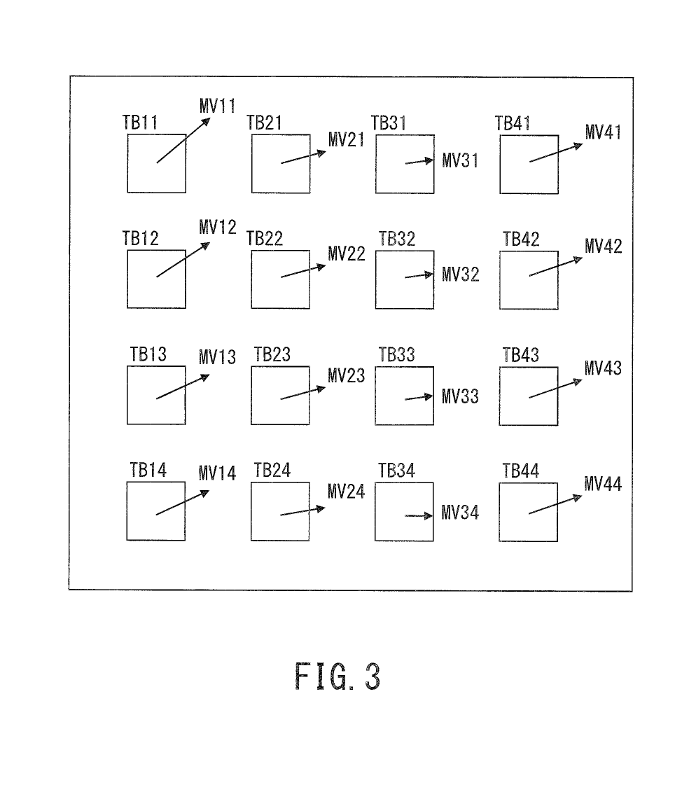

The motion information acquiring unit 104 acquires a motion between the reference image and the target image stored in the frame memory 103 as motion information. In this embodiment, the motion information acquiring unit 104 outputs motion vectors at a plurality of positions set in an image using a block matching method. FIG. 3 is a diagram showing the block matching method. First, plurality of target blocks are set in a reference image. In an example of FIG. 3, four target blocks are set in a horizontal direction and four target blocks are set in a vertical direction, i.e. a total of 16 target blocks (TB11 to TB44) are set. For these respective target blocks, motion vector search areas are set in a target image and a motion vector with a minimum SAD value (sum of absolute differences in the blocks) in each vector search area is detected and output to the synthesis processing unit 105 (MV11 to MV44).

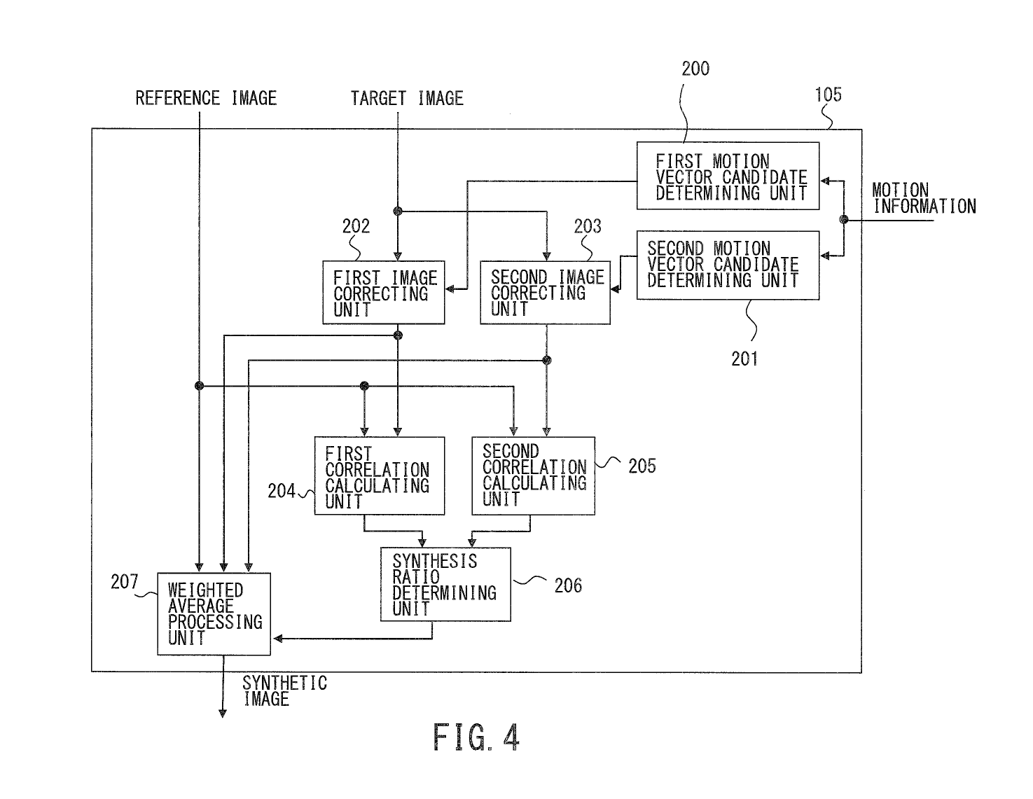

The synthesis processing unit 105 synthesizes the reference image and the target image based on the motion information (motion vectors corresponding to the number of target blocks) output from the motion information acquiring unit 104. FIG. 4 shows a construction diagram of the synthesis processing unit 105.

The synthesis processing unit 105 includes a first motion vector candidate determining unit 200, a second motion vector candidate determining unit 201, a first image correcting unit 202, a second image correcting unit 203, a first correlation calculating unit 204, a second correlation calculating unit 205, a synthesis ratio determining unit 206 and a weighted average processing unit 207.

The first motion vector candidate determining unit 200 calculates a first motion vector candidate of a processing target pixel from N pieces of motion information (motion vectors) output from the motion information acquiring unit 104. “N” is a natural number. At this time, the motion information to be referred to is motion information (motion vectors) in a small local area around the processing target pixel.

The second motion vector candidate determining unit 201 calculates a second motion vector candidate of the processing target pixel from M pieces of motion information (motion vectors) output from the motion information acquiring unit 104. “M” is a natural number greater than “N”. At this time, the motion information to be referred to is motion information (motion vectors) in a large global area around the processing target pixel. The global area is an area larger than the local area.

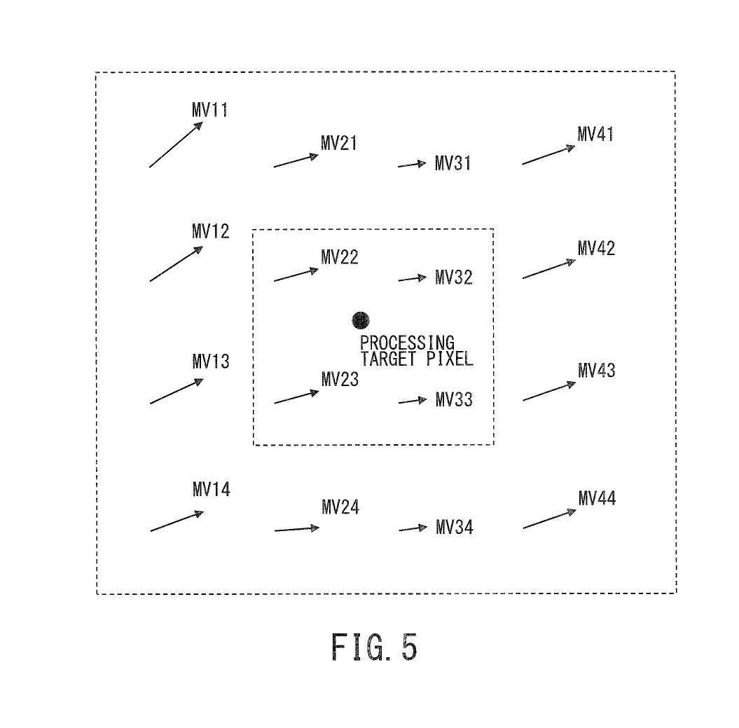

FIG. 5 is a diagram showing this state. The motion vectors detected by the motion information acquiring unit 104 (MV11 to MV44 in FIG. 5) are present around the processing target pixel. The first motion vector candidate determining unit 200 calculates the first motion vector candidate at the processing target pixel position based on four motion vectors (MV22, MV32, MV23, MV33) near the processing target pixel. The calculated first motion vector candidate may be an average value of the four vectors or a weighted average value thereof in consideration of distances between the processing target pixel position and the positions of the respective motion vectors. By doing so, the first motion vector candidate determined by the first motion vector candidate determining unit 200 can be expected to be a motion vector with high accuracy strongly reflecting a local motion in the small range but, on the other hand, may be an unstable vector susceptible to noise and the like.

On the other hand, the second motion vector candidate determining unit 201 calculates the second motion vector candidate at the processing target pixel position based on sixteen motion vectors (MV11 to MV44) near the processing target pixel. The calculated second motion vector candidate may be an average value or a weighted average value of the sixteen vectors or a histogram process may be performed on these motion vectors and the motion vector having a highest occurrence frequency may be used as such. By doing so, the second motion vector candidate determined by the second motion vector candidate determining unit 201 may be a motion vector with low accuracy incapable of reflecting local motions although reflecting a global motion in the large range but, on the other hand, can be expected to be a stable motion vector unsusceptible to noise and the like.

Note that the first motion vector candidate determining unit 200 calculates the first motion vector candidate at the processing target pixel position based on four motion vectors and the second motion vector candidate determining unit 201 calculates the second motion vector candidate at the processing target pixel position based on sixteen motion vectors in FIG. 5, but this is an example and the calculation method is not limited to this.

The first image correcting unit 202 deforms the target image based on the first motion vector candidate calculated by the first motion vector candidate determining unit 200. The second image correcting unit 203 deforms the target image based on the second motion vector candidate calculated by the second motion vector candidate determining unit 201. Specifically, the first and second image correcting units 202, 203 calculate pixel positions of the target image corresponding to the processing target pixel position in the reference image from the respective motion vectors and obtain pixel values.

The first correlation calculating unit 204 calculates a correlation value between the processing target pixel of the reference image and the pixel related by the first image correcting unit 202. Further, the second correlation calculating unit 205 calculates a correlation value between the processing target pixel of the reference image and the pixel related by the second image correcting unit 203. Specifically, the correlation value is the absolute value of a difference between pixel values or the like. If the absolute value of this difference is small (correlation is high), the motion vector has a high possibility of being proper and can be used for the synthesis process. If the absolute value of this difference is large (correlation is low), the motion vector may not be proper and is judged to be unusable for the synthesis process. Note that the correlation value may be a sum of absolute differences of a small block (3×3 pixels or 5×5 pixels) instead of the absolute difference of the pixel values. At this time, the pixel value of the reference image used is a pixel value of the small block around the processing target pixel, and the pixel value of the target image is a pixel value of a corresponding small block in an image obtained by correcting the target image by the respective motion vectors.

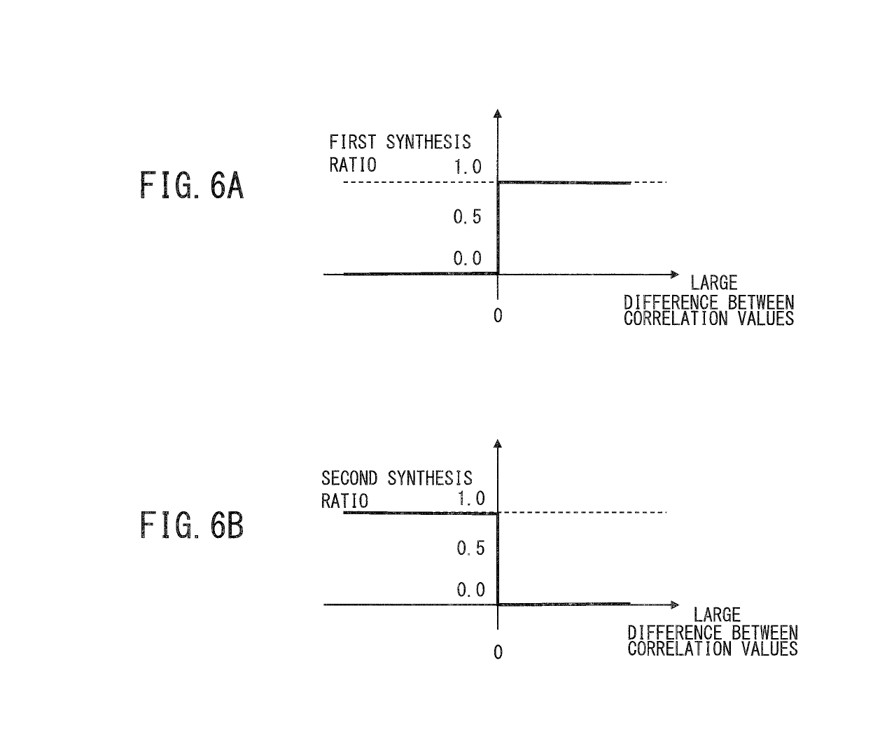

The synthesis ratio determining unit 206 determines a weight (synthesis ratio) in the weighted average processing unit 207 according to the correlation values (absolute differences) calculated by the first and second correlation calculating units 204, 205. FIGS. 6A and 6B show examples of a method for determining the synthesis ratio. FIG. 6A is a graph showing a relationship between difference between correlation values and first synthesis ratio. FIG. 6B is a graph showing a relationship between difference between correlation values and second synthesis ratio.

The first synthesis ratio in FIG. 6A is a weight of an output pixel value of the first image correcting unit 202 and the second synthesis ratio in FIG. 6B is a weight of an output pixel value of the second image correcting unit 203 when a weight of the pixel value of the reference image is 1.0. The difference between the correlation values in FIGS. 6A and 6B is a value obtained by subtracting the correlation value (absolute difference) calculated by the first correlation calculating unit 204 from the correlation value (absolute difference) calculated by the second correlation calculating unit 205. It means that the output pixel value of the first image correcting unit 202 has a high correlation with the pixel value of the reference image if this difference between the correlation values is a positive value, whereas the output pixel value of the second image correcting unit 203 has a high correlation with the pixel value of the reference image if it is a negative value. In the examples shown in FIGS. 6A and 6B, out of the output pixel value of the first image correcting unit 202 and that of the second image correcting unit 203, only the pixel value having a higher correlation with the pixel value of the reference image is used for synthesis in the weighted average processing unit 207.

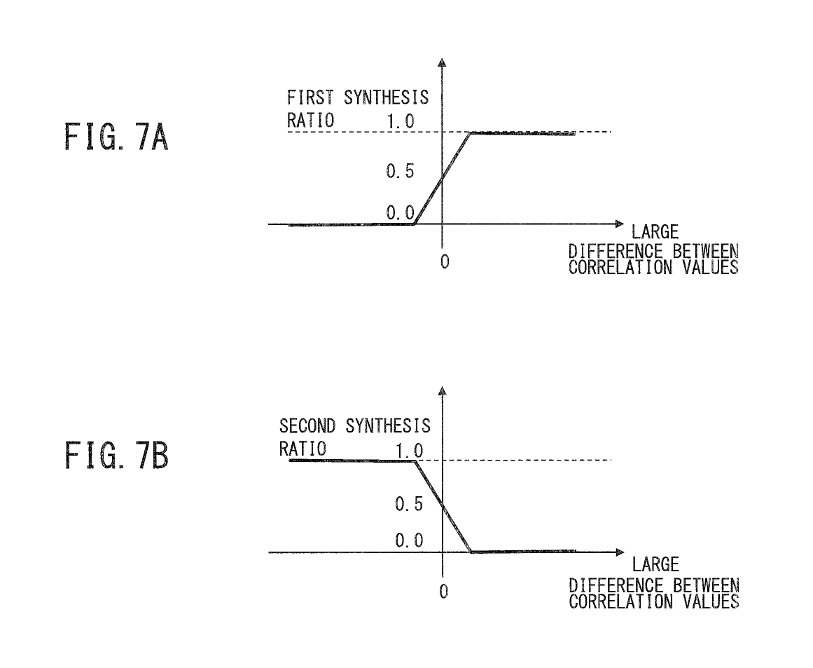

Besides, if the absolute value of the difference between the correlation values is small, it is also possible to use the both pixel values for synthesis by moderately changing the synthesis ratio from 0.0 to 1.0 as in examples shown in FIGS. 7A and 7B. FIG. 7A is a graph showing a relationship between difference between correlation values and first synthesis ratio. FIG. 7B is a graph showing a relationship between difference between correlation values and second synthesis ratio.

If both of the correlation values calculated by the first and second correlation calculating units 204, 205 are smaller than a predetermined threshold (absolute differences between the pixel values are both larger than a predetermined threshold), it is also possible to judge that neither of the motion vector candidates is proper and set the first and second synthesis ratios to 0 so that neither of the pixels is used for synthesis.

The weighted average processing unit 207 performs a weighted average process between the pixel of the reference image, the output pixel of the first image correcting unit 202 and the output pixel of the second image correcting unit 203 based on the synthesis ratio output from the synthesis ratio determining unit 206 and determines the resultant pixel as a pixel of the synthetic image.

The synthetic image is obtained by performing the process as described above on all the pixels in the image.

Although the respective motion vector candidates are calculated by the first and second motion vector candidate determining units 200, 201 for each unit area composed of one pixel at all the pixels in the image in this embodiment, they may be calculated for each unit area composed of a plurality of pixels. For example, the unit area is a block composed of 16×16 pixels and the same motion vector candidate is used in this block. By doing so, a calculation amount necessary to determine the motion vector candidate can be reduced. Further, the second motion vector candidate determined by the second motion vector candidate determining unit may be a global motion vector (one motion vector representing the entire image). By doing so, the calculation amount of the second motion vector candidate determining unit 201 can be further reduced.

Although two motion vector candidates are calculated in this embodiment, three or more motion vector candidates may be calculated.

Effects of the first embodiment of the present invention are described.

Image synthesis satisfying both high accurate position adjustment in the entire image and stable position adjustment unsusceptible to noise and the like is possible by determining the first motion vector candidates with reference to the local areas near the processing target pixels by the first motion vector candidate determining unit 200, determining the second motion vector candidates with reference to the global areas near the processing target pixels by the second motion vector candidate determining unit 201 and performing the synthesis process using these as in this embodiment.

Further, a plurality of motion vector candidates having different characteristics can be obtained without repeating the block matching process requiring an enormous calculation amount by calculating a plurality of motion vector candidates having different characteristics by the first and second motion vector candidate determining units 200, 201 from the motion information (a plurality of motion vectors) calculated by the motion information acquiring unit 104 as in this embodiment.

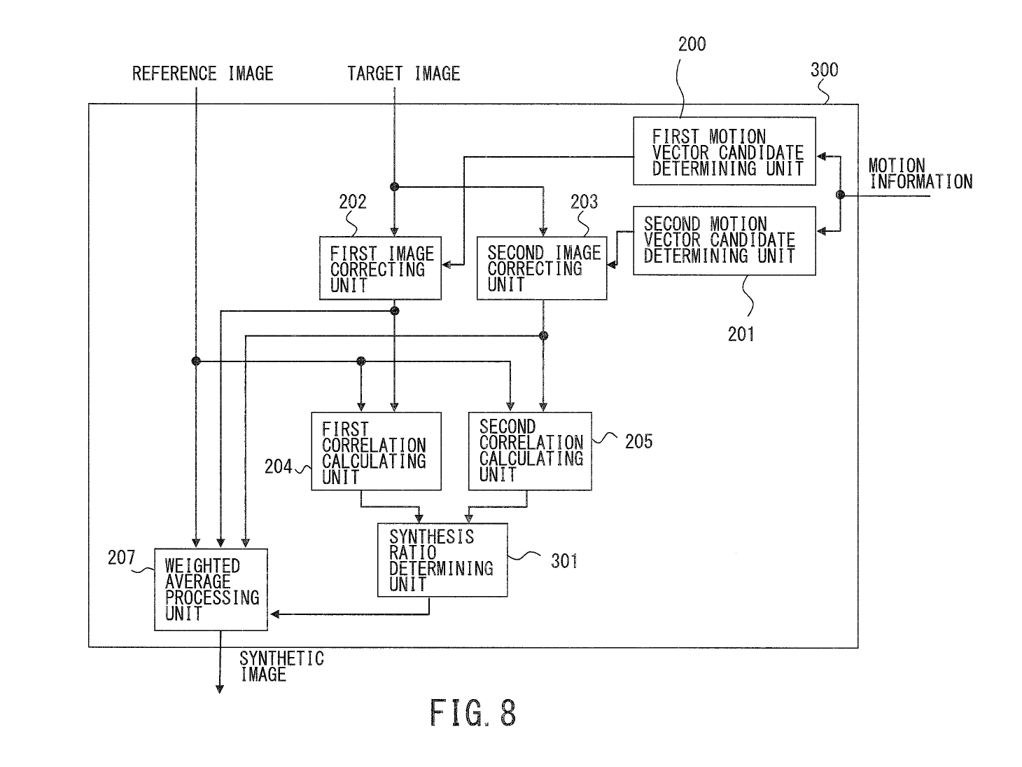

Next, a second embodiment of the present invention is described with reference to FIG. 8. FIG. 8 is a schematic construction diagram showing a synthesis processing unit 300 of the second embodiment.

In the second embodiment, a synthesis ratio determining unit 301 of the synthesis processing unit 300 differs from that in the first embodiment. The description of the second embodiment is centered on parts different from the first embodiment. In FIG. 8, the same construction as the first embodiment is denoted by the same reference numerals as the first embodiment and not described here.

In the first embodiment, the first motion vector candidate determined with reference to the local area near the processing target pixel and the second motion vector candidate determined with reference to the global area near the processing target pixel are calculated and the first and second synthesis ratios are determined based on the differences between the correlation values. The determination of the first and second synthesis ratios at this time is made on the same evaluation scale at any pixel position in the image. That is, the first and second synthesis ratios are not changed according to the pixel position. In this embodiment, synthesis ratios are changed according the pixel position in an image.

If a distortion resulting from an optical system 100 is strongly present in a picked-up image, there is a strong influence of this distortion at pixels near a screen end. Thus, synthesis is preferably performed using an image corrected by first motion vector candidates determined with reference to local areas by a first motion vector candidate determining unit 200 more likely than by second motion vector candidates determined with reference to global areas by the second motion vector candidate determining unit 201 at pixels near the screen end.

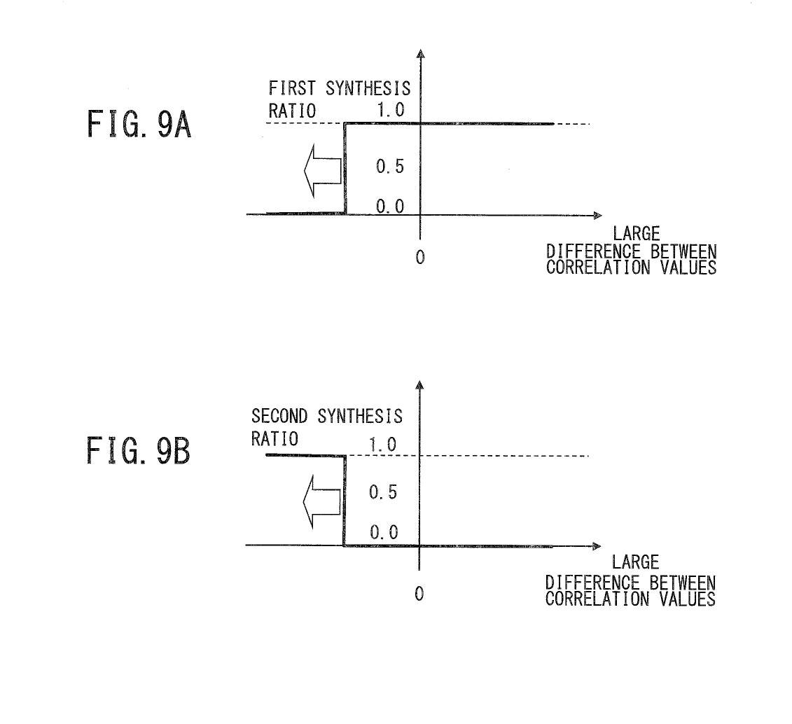

To realize such a characteristic, the synthesis ratio determining unit 301 is caused to operate as shown in FIGS. 9A and 9B in this embodiment. FIG. 9A is a graph showing a relationship between difference between correlation values and first synthesis ratio. FIG. 9B is a graph showing a relationship between difference between correlation values and second synthesis ratio.

Distortion information of the optical system 100 is set beforehand in the synthesis ratio determining unit 301. A distortion amount at a processing target pixel position is calculated from a pixel position and the distortion information. The relationship between the difference between the correlation values and the synthesis ratio is changed according to the pixel position as shown in FIGS. 9A, 9B to make the first synthesis ratio easily become 1.0 and the second synthesis ratio easily become 0.0 as the distortion amount increases. Specifically, offset values corresponding to calculated distortion amounts are set by tabulation or another technique, the first synthesis ratio is easily set to 1.0 in an area where the distortion amount is large by shifting the difference between the correlation values at which the first synthesis ratio changes from 0.0 to 1.0 by the corresponding offset, and image synthesis is performed using an image corrected using the first motion vector candidates with reference to the local areas.

Effects of the second embodiment of the present invention are described.

By making the synthesis ratio changeable according to the pixel position as in this embodiment, it becomes possible to suppress deterioration in position adjustment accuracy resulting from the pixel positions in addition to the effects in the first embodiment. For example, by making it more likely to perform image synthesis using an image corrected by the first motion vector candidates determined with reference to local areas in an area where the distortion amount of the optical system 100 is large, deterioration in the position adjustment accuracy resulting from the distortion of the optical system 100 can be suppressed.

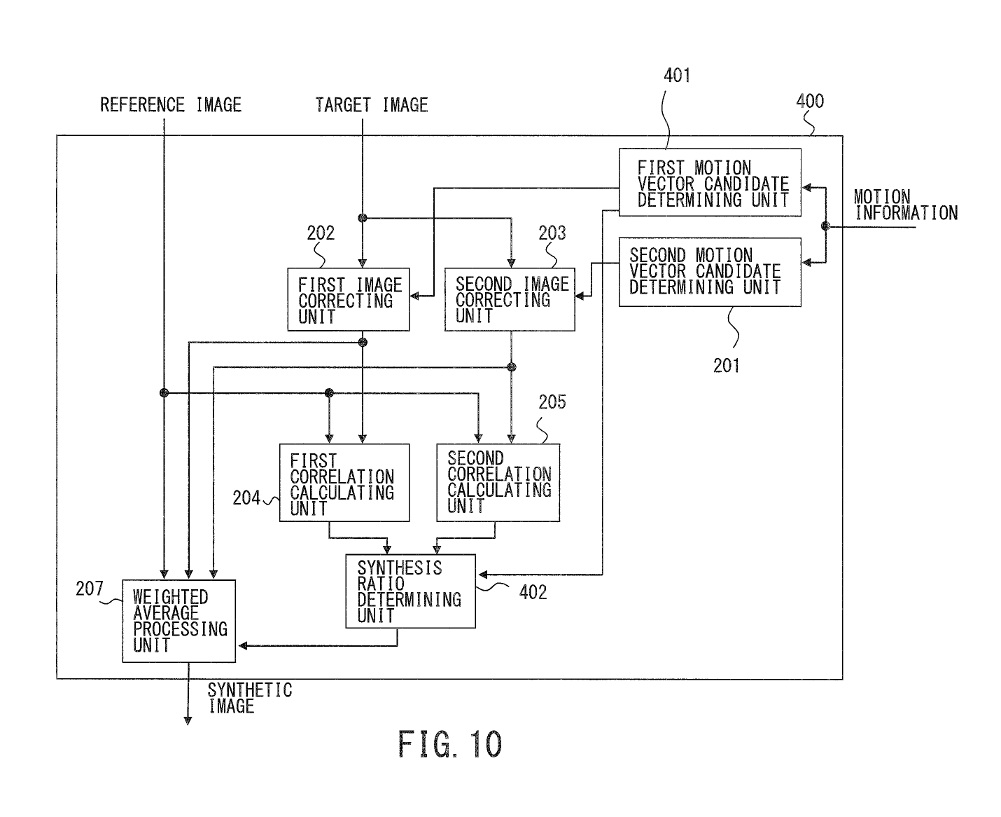

Next, a third embodiment of the present invention is described with reference to FIG. 10. FIG. 10 is a block diagram showing a synthesis processing unit 400 according to the third embodiment.

In the third embodiment, a first motion vector candidate determining unit 401 and a synthesis ratio determining unit 402 in the synthesis processing unit 400 differ from those of the first embodiment. The description of the third embodiment is centered on parts different from the first embodiment. In FIG. 10, the same construction as the first embodiment is denoted by the same reference numerals as the first embodiment and not described here.

Respective motion vectors calculated by a motion information acquiring unit 104 become unstable also when the content of an image is not suitable for block matching in addition to having a problem of becoming unstable due to noise and the like. For example, when there is a flat low contrast area in an image, a large number of motion vectors having a small SAD value are generated if the motion vectors are searched by block matching. Even if the motion vector having the minimum SAD value out of these motion vectors is determined as a motion vector, the reliability of this determination is low. Alternatively, when there is a repeating pattern in an image, a motion vector having a small SAD value is generated in a repeating cycle. Thus, reliability is low as in the low contrast area. Such phenomena can be predicted by analyzing the SAD values calculated in the course of a block matching process. For example, if a difference between a SAD value indicating a minimum value and that indicating a second minimum among searched motion vectors is equal to or smaller than a predetermined threshold, the reliability of the motion vector indicating the minimum value is possibly judged to be low.

In this embodiment, reliability information is calculated in addition to motion vectors at respective positions of an image and these are used as motion information in the block matching process in the motion information acquiring unit 104.

In the synthesis processing unit 400, the reliability information is referred to and, if a motion vector with low reliability is present in the vicinity, image synthesis is more likely to be performed using an image corrected using second motion vector candidates determined with reference to global areas by the second motion vector candidate determining unit 201 than first motion vector candidates determined with reference to local areas by the first motion vector candidate determining unit 401.

The motion information composed of the reliability information and the motion vector information is input to the first motion vector candidate determining unit 401.

The first motion vector candidate determining unit 401 calculates a first motion vector candidate with reference to a nearby local area similar to the first motion vector candidate determining unit 200 in the first embodiment, counts the number of motion vectors with low reliability included in this area and outputs the count value to the synthesis ratio determining unit 402. For example, if MV22 and MV32 are motion vectors with low reliability out of MV22, MV32, MV23 and MV33 in FIG. 5, these are counted and a value of 2 is output to the synthesis ratio determining unit 402.

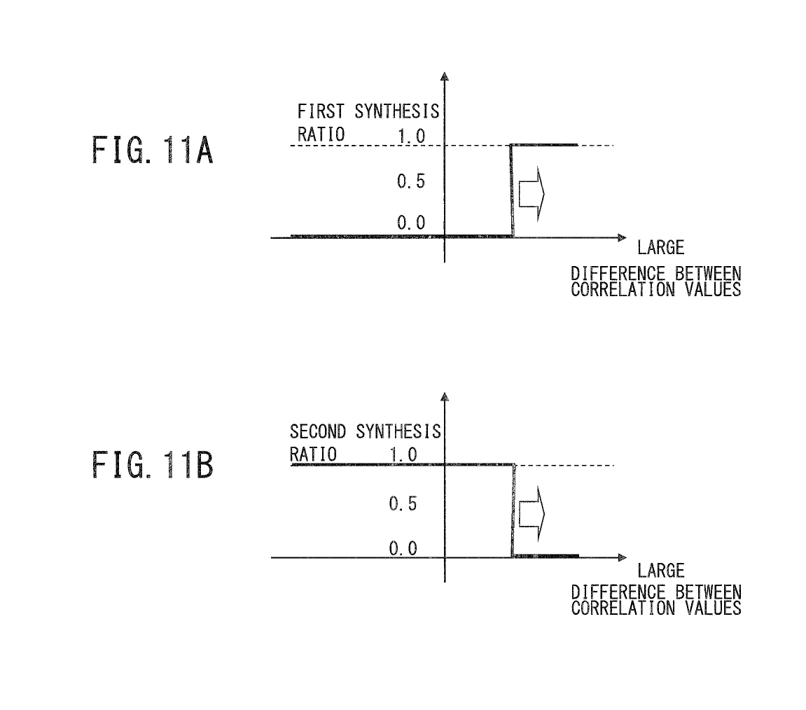

The synthesis ratio determining unit 402 determines the synthesis ratio similar to the synthesis ratio determining unit 206 in the first embodiment. A relationship between difference between correlation values and synthesis ratio is changed based on the reliability of the motion vectors as shown in FIGS. 11A, 11B to make the first synthesis ratio easily become 0.0 and the second synthesis ratio easily become 1.0 as the number of the motion vectors with low reliability increases. FIG. 11A is a graph showing a relationship between difference between correlation values and first synthesis ratio. FIG. 11B is a graph showing a relationship between difference between correlation values and second synthesis ratio. Specifically, offset values corresponding to the numbers of motion vectors with low reliability are set by tabulation or another technique, the first synthesis ratio easily becomes 0.0 in an area where there are many motion vectors with low reliability by shifting the difference between the correlation values at which the first synthesis ratio changes from 0.0 to 1.0 by the corresponding offset and image synthesis is performed using an image corrected using the second motion vector candidates with reference to the global areas.

Effects of the third embodiment of the present invention are described.

By making the synthesis ratio changeable based on the reliability of the motion vectors as in this embodiment, an effect of improving stability in position adjustment can be obtained in addition to the effects in the first embodiment.

Note that the second and third embodiments may be combined.

Although a hardware process is assumed as the process performed by the image processing apparatus in the description of the above embodiments, limitation to such a construction is not necessary. For example, the process may be alternatively performed by software.

In this case, the image processing apparatus includes a CPU, a main storage such as a RAM and a non-temporary computer-readable storage medium storing a program for realizing the entirety or part of the above process. Here, this program is called an image processing program. The CPU reads the image processing program stored in the above storage medium and performs information processing/arithmetic processing, thereby realizing a process similar to the process of the image processing apparatus by the hardware.

Here, the non-temporary computer-readable storage medium is a magnetic disc, a magneto-optical disc, a CD-ROM, a DVD-ROM, a semiconductor memory or the like. Further, this image processing program may be delivered to a computer via a communication line and the computer having received this delivery may perform the image processing program.

The present invention is not limited to the above embodiments and it goes without saying that various changes and improvements, which can be made without departing from the scope of the technical concept of the present invention, are included.

The present application claims a priority based on Japanese Patent Application No. 2010-186950 filed with the Japanese Patent Office on Aug. 24, 2010, all the contents of which are hereby incorporated by reference.

What is claimed is:

1. An image processing apparatus for synthesizing a plurality of images, comprising:
an image acquiring unit that acquires a plurality of images;
a motion information acquiring unit that acquires motion information between the plurality of images; and
a synthesizing unit that corrects at least one image out of the plurality of images based on the motion information and synthesizes the corrected image and at least one other image acquired by the image acquiring unit;
wherein the synthesizing unit:
comprises a first motion vector candidate calculating unit that calculates a first motion vector candidate corresponding to a local area near a unit area for each unit area composed of a single pixel or a plurality of pixels, and a second motion vector candidate calculating unit that calculates a second motion vector candidate corresponding to a global area near the unit area and larger than the local area for each unit area; and
corrects at least one image out of the plurality of images based on at least either the first motion vector candidates or the second motion vector candidates and synthesizes the corrected image and the at least one other image acquired by the image acquiring unit.

2. The image processing apparatus according to claim 1, wherein:
the motion information acquiring unit calculates motion vectors in a plurality of areas in an image for each unit area;
the first motion vector candidate calculating unit calculates the first motion vector candidate from N (N is a natural number) motion vectors near the unit area; and
the second motion vector candidate calculating unit calculates the second motion vector candidate from M (M is a natural number greater than N) motion vectors near the unit area.

3. The image processing apparatus according to claim 1, wherein the synthesizing unit:
comprises a synthesis ratio determining unit that determines a synthesis ratio of an image corrected based on the first motion vector candidates and an image corrected based on the second motion vector candidates according to a pixel position; and
synthesizes the corrected image and the at least one other image acquired by the image acquiring unit based on the synthesis ratio.

4. The image processing apparatus according to claim 3, wherein the synthesis ratio determining unit changes the synthesis ratio based on a distortion amount of an imaging optical system corresponding to the pixel position.

5. The image processing apparatus according to claim 1, wherein the synthesizing unit:
comprises a synthesis ratio determining unit that determines a synthesis ratio of an image corrected based on the first motion vector candidates and an image corrected based on the second motion vector candidates based on reliability of the motion information; and
synthesizes the corrected image and the at least one other image acquired by the image acquiring unit based on the synthesis ratio.

6. A non-temporary computer-readable storage medium storing an image processing program for processing a picked-up image by a computer, the image processing program causing the computer to perform:
an image acquiring procedure for acquiring a plurality of images;
a motion information acquiring procedure for acquiring motion information between the plurality of images; and
a synthesizing procedure for correcting at least one image out of the plurality of images based on the motion information and synthesizing the corrected image and at least one other image acquired by the image acquiring procedure;
wherein, in the synthesizing procedure,
a first motion vector candidate calculating procedure for calculating a first motion vector candidate corresponding to a local area near a unit area for each unit area composed of a single pixel or a plurality of pixels, and a second motion vector candidate calculating procedure for calculating a second motion vector candidate corresponding to a global area near the unit area and larger than the local area for each unit area are further performed; and
at least one image out of the plurality of images is corrected based on at least either the first motion vector candidates or the second motion vector candidates and the corrected image and the at least one other image acquired by the image acquiring procedure are synthesized.
